(19) United States
(12) Patent Application Publication
(10) Pub. No.: US 2003/0004743 A1
(43) Pub. Date: Jan. 2, 2003

(54) Methods for providing a location based merchant presence

(76) Inventor: Jeff Callegari, Kirkland, WA (US)

Correspondence Address: Mark W. Roberts, Esq., DORSEY & WHITNEY LLP, Suite 3400, 1420 Fifth Avenue, Seattle, WA, 98101, US

(21) Appl. No.: 10/102,605

(22) Filed: Mar. 19, 2002

Related U.S. Application Data
(60) Provisional application No. 60/277,174, filed on Mar. 19, 2001.
(60) Provisional application No. 60/277,200, filed on Mar. 19, 2001.
(60) Provisional application No. 60/277,187, filed on Mar. 19, 2001.

(51) Int. Cl. G06F 17/60

(52) U.S. Cl. 705/1

(57) ABSTRACT

Methods and systems for providing a merchant presence to a consumer based on the respective locations of the consumer and the merchant are disclosed. The methods include determining the location of the consumer by receiving an indication of the consumer's location from a consumer device and transmitting an electronic message regarding the merchant's presence to the consumer device only if the indicated location of the consumer is the same as, overlaps with, or comes within a service area, that defines the location of the merchant. The merchant's presence is actively “pushed” to the consumer based on detecting the consumer's location without need of the consumer to conduct an active search for the merchant. The consumer's location may be continuously tracked using geo positioning coordinates and the merchant presence is updated based on the consumer's changing locations. The merchant presence is transmitted in any of a variety of format compatible with the consumer device.

### CROSS-REFERENCE TO RELATED APPLICATIONS

This application is a sibling of co-pending application Nos. ______ and ______, and claims priority to provisional patent application Nos. 60/277,174, 60/277,200 and 60/277,187, all filed Mar. 19, 2001, all of which are incorporated herein by reference in their entirety.

### TECHNICAL FIELD

The invention relates generally to location based methods for providing information to a consumer regarding the presence of a merchant. More particularly, it pertains to actively providing information concerning the merchant's presence to a consumer whenever the consumer indicates a location, or is detected within a location, that is serviced by the merchant and the consumer evinces an interest in the type of business provided by the merchant.

### COPYRIGHT NOTICE—PERMISSION

A portion of the disclosure of this patent document contains materials, which are subject to copyright protection. The copyright owner has no objection to the facsimile reproduction by anyone of the patent document or the patent disclosure as it appears in the Patent and Trademark Office patent files or records, but otherwise reserves all copyrights rights whatsoever. The following notice applies to the software and data as described below and in the drawings attached hereto: Copyright© 2001, Cellular Technical Services Company, Inc., All Rights Reserved.

### BACKGROUND OF THE INVENTION

The need for consumers to identify merchants to obtain goods and/or services within a particular geographical area and the corresponding need for merchants to make their presence known to the consumer in that area has long been recognized as an important aspect of business contact. The classic, hard copy solution to the need is exemplified by directories that cover a particular geographical area, for example a telephone book for a city, where addresses and contact information for merchants within that area are organized by category in alphabetical order. The consumer in need of services within the area consults the directory, views the entries and selects merchants based on the consumer's recognition of the merchant's address. Often merchants provide some form of advertising in such directories to attract attention to their particular presence.

One problem with hard copy directories is that they are bulky and time consuming to use. Another problem is that the information is not location specific other than being within the region covered by the directory. Still another problem is that the information stored in such directories is necessarily static, therefore, merchants are not able to immediately update records or provide continuously updated information such as special product offerings, coupons and the like. For this, merchants rely typically on newspapers and/or direct mail campaign within the desired geographic area.

More recently, the World Wide Web has become an important resource that provides directories, databases, web sites, web pages and a variety of merchant information in electronic form, stored on a server that can be accessed by the consumer through use of a personal computer. Typically, the consumer uses some sort of search engine to search the World Wide Web for certain words or concepts related to the class of goods or services that they seek. In some cases, an Internet Service Provider (ISP) may assemble merchant information by category to permit consumers to search databases for merchants listed within those categories. In other cases, a program may be provided that allows consumers to query the database with a location field, typically a zip code or address, in order to obtain a list of merchants having nearby addresses or zip codes.

One of the problems with the World Wide Web is that it is not location specific for either the merchant or consumer. The merchant is unable to target consumers within a specified geographical location because the merchant relies on the consumer to discover the merchants presence through an active search. The consumer must conduct a search, specify a location, and usually proceed through multiple steps in a series of database queries each time the consumer wants information. In essence, the consumer must “pull” information from the databases based on the consumer's skill in locating a proper search engine or application for constructing an effective search. Another problem with the World Wide Web is that the merchant information is not variable according to location. For example, if a merchant has special offers in one geographic location but not another, the only way to distinguish the offers in the different locations is to have multiple database entries (e.g., multiple web sites or multiple pages within a site), or to provide an overview of all offers, which requires the consumer to further search to discover whether the offer is good in the consumer's location of interest.

Mobile communication technology now permits consumers to access the World Wide Web using portable devices such as cell phones, portable computers, portable digital assistants, “BLACKBERRIES” and the like. These devices use a varied assortment of protocols and/or formats for receiving and transmitting information including, for example, Wireless Application Protocol, HTML and E-mail. These technologies allow consumers to access information from a mobile platform without being restricted by physical location. Mobile connection to the World Wide Web has all the same limitations as the World Wide Web with regard to consumer searching to locate merchants. Another problem with mobile communication technology stems from the variety of protocols and formats in use, which prevents merchant information from being communicated to the mobile device unless the information and the device use compatible protocols and formats. Still another disadvantage is that these technologies also do not permit the consumer to input location specific information although the consumer is in-fact moving between a variety of locations.

Another type of information service combines mobile communications with various position determining equipment (PDE) to send or receive positional information regarding the consumer's locations. Enterprises that provide positioning equipment and/or locating services are variously called Location Service Providers (LSP), Mobile Positioning Centers (MPC) or Global Positioning Satellite (GPS) services. Example technologies for locating a consumer's position include GPS systems, assisted GPS systems (A-GPS), time domain of arrival systems (TDA) or signal triangulation systems. One example of a commercial A-GPS service is provided under the service mark NORTHSTAR, which uses positioning satellites to identify the latitude and longitude of a consumer equipped with GPS positioning equipment. The longitude and latitude are in turn received by the service provider which uses the information to conduct a database search to find merchants located in the vicinity of the consumer. Such services have the same limitations as the World Wide Web in terms of locating merchants because the service provider also must pull information from a database using an active search. Merchants are not able to make their presence known to the consumer unless specifically requested by the operator or provider of the service.

There is, therefore, a need in the art for methods and systems that put merchants in contact with consumers on the basis of location, so that a merchant's presence may be made known to the consumer in a location specific manner, and which allows the consumer to readily find merchants within a location without the need for active database query instructions.

### SUMMARY OF THE INVENTION

The present invention fulfills these and other needs that will be apparent from the following description of various aspects of the invention. An illustrative aspect of the invention includes a method for providing a merchant presence to a consumer. The method includes receiving merchant information in electronic medium that defines the merchant presence. The merchant information includes a defined location for the merchant and a category of goods and/or services offered by the merchant. Information from a consumer device is received that includes an indication of the consumer's location without specifying an active search for the merchant. If the indication of the consumer location overlaps with the defined location for the merchant, the merchant presence is actively transmitted to the consumer device in response to receiving the indication of the consumer's location.

In certain embodiments, the indication of the consumer location includes a point of origin for the consumer and an area of interest defined by the consumer, and the merchant presence is transmitted to the consumer device only if the merchant location is within the area of interest defined by the consumer. In other embodiments, the defined location for the merchant includes a point of origin for the merchant and a service area defined by the merchant; and the merchant presence is transmitted to the consumer device only if the if the indication of the consumer location is within the service area defined by the merchant.

In typical embodiments, the method also includes receiving an indication of a consumer's category of goods and services from the consumer device, and the merchant presence is transmitted to the consumer device only if the consumer's category of goods and services overlaps with the merchant's category of goods and/or services.

Certain embodiments also include determining a protocol and/or a format that is compatible with the consumer device and using a device interface to transmit the merchant presence to the consumer device using the compatible protocol and/or format. Compatible protocols and/or formats include, Wireless Application Protocol, Wireless Markup Language (WML), Voice eXtensible Markup Language (VoiceXML), Short Message Service (SMS), HTML, XHTML and E-mail. The device interface may also include a program environment where applications are executing within the device and communicating directly to another “resource” such as a server using standard or proprietary protocols. Some embodiments further include tracking the activity of each consumer in regard to transmissions of the merchant presence. Typically, activity tracking is selectively enabled by the consumer or the merchant.

Certain embodiments include tracking the position of the consumer using geo-positioning information provided by the consumer device on a continuous or periodic basis. In these embodiments, the content of the merchant presences is continuously changed and continuously pushed to the consumer device as the consumer changes physical locations.

Systems and applications for implementing the various embodiments of the invention are also described. All of the embodiments of the present invention provide quick, easy and direct interaction between the merchant and consumer using a location aware presence server that actively puts merchants in contact with consumers based on their respective geographic locations.

### BRIEF DESCRIPTION OF THE DRAWINGS

FIG. 1 illustrates features of merchants, consumers and locations according to one aspect of the present invention.

FIG. 2 illustrates other features of merchants, consumers and locations according to one aspect of the present invention.

FIG. 3 is a pictorial diagram of a consumer view of a merchant presence according to one aspect of the present invention.

FIG. 4 is a pictorial diagram of a user interface for scanning for a merchant presence according to one aspect of the present invention.

FIG. 5A is a block diagram of a basic system according to one aspect of the present invention.

FIG. 5B is a block diagram of an expanded system according to one aspect of the present invention.

FIG. 6 is a pictorial diagram of a merchant interface for allowing a merchant to establish a merchant presence according to one aspect of the present invention.

FIG. 7 is a schematic diagram of an Application that implements methods according to one aspect of the present invention.

FIG. 8 is a pictorial diagram of a GUI for configuring a device interface for communication with a consumer device according to one aspect of the invention.

FIG. 9 is a pictorial diagram of a GUI for selecting a private service context according to one aspect of the invention.

### DETAILED DESCRIPTION OF THE INVENTION

In the following detailed description of exemplary embodiments of the invention, reference is made to the accompanying drawings, which form a part hereof, and in which are shown, by way of illustration, specific exemplary embodiments in which the invention may be practiced. In the drawings, like numerals describe substantially similar components throughout the several views. These embodiments are described in sufficient detail to enable those skilled in the art to practice the invention. Other embodiments may be utilized and structural, logical, electrical, and other changes may be made without departing from the spirit or scope of the present invention. The following detailed description is, therefore, not to be taken in a limiting sense, and the scope of the present invention is defined only by the appended claims.

As used herein, the term “merchant presence” is information content that is stored on electronic medium that concerns goods and/or services provided by a merchant and an identifier of the merchant, which is transmitted from the merchant to an electronic communication device of a consumer. The term “wired”, with respect to a communication device includes any hard line data communication conduit, including, for example, cable, telephone lines, fiber optic lines and the like. The term “wireless” includes any device that communicates data without need of a hard line.

The term “consumer” refers to any person, business enterprise or other entity that desires to obtain goods and/or services from another. The term “merchant” refers to any person, business enterprise or other entity that provides goods and/or services to another. Merchants become consumers when they seek goods and/or services and consumers become merchants when they provide goods and/or services. Accordingly a single person, business enterprise or other entity may be a consumer in one circumstance and a merchant in another. Therefore, the terms merchant and consumer are not exclusive of one another. A “user” refers to any person, business enterprise or other entity that communicates with, and/or subscribes to, a service that implements the methods and/or systems described herein.

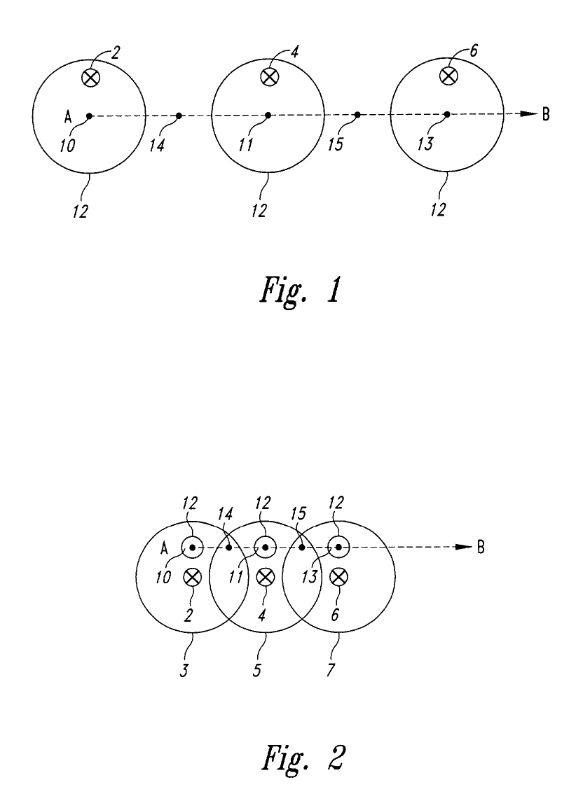

FIG. 1 illustrates features of merchants, consumers and locations used in various embodiments of this invention. A plurality of merchants offer goods or services from a plurality of defined points of origin for the merchants 2, 4, and 6. The merchants' points of origins may be precisely defined, for example, by an address or by positioning coordinates such as longitude and latitude. The consumer is similarly located at a defined point of origin 10. The consumer may define a geographic area of interest 12 surrounding the consumers point of origin 10 for which goods, services or other information may be desired. Typically, the consumer may wish to define the area of interest 12 differently from time to time. At one time the consumer may, for example, define the area of interest as within a city, while at another time may define the area of interest as within a neighborhood, on a street, or within a certain defined distance from the consumer's home or present point of origin 10. The size of the area of interest 12 may be user defined, assigned by a service provider, or selected by the consumer from a list of options. The area of interest 12 may for example, be defined as a geometric area encompassed by an ellipse or rectangle with a perimeter located a specified distance from the consumer's points of origins 12. Alternatively, the service area may be defined by socio-political boundaries, such as the boundaries of a neighborhood, city or other circumscribed region The areas of interest 12 may, therefore, be any size, for example, as small as the width of a shop window or as large as a state.

The consumer's point of origin 10 and area of interest 12 may change discretely, for example, when the consumer moves domiciles, or may change continuously over time, for example, during a trip where the consumer travels from point A to point B and thereby crosses a number of points of origin exemplified by points 11, 13, 14 and 15 traversed during the travel. The trip may be on a large scale, for example, between cities, or on a small scale, for example, down a city street or retail mall. As the consumer changes from a first point of origin 10 to a second point of origin 11, 13, 14 or 15, the geographic area of interest 12 changes with the consumer's location. At various points, the consumer's area of interest 12 encompasses different merchants at different points of origin 2, 4 and 6.

In one aspect, there are provided methods for merchants to transmit their presence to a consumer based on the consumer's area of interest 12 and the merchant's point of origin 2, 4 or 6. Merchants typically desire to make their presence known to consumers when the consumer is nearby, i.e., when the consumer's point of origin and/or area of interest 12 is essentially the same as the merchant's point of origin, overlaps with the merchant's point of origin, or comes within a service area targeted by the merchant. Conversely, the consumer is typically most interested in knowing of a merchant's presence when the consumer's area of interest 12 is near the merchant's point of origin. Accordingly, when the consumer is at point of origin 10 the consumer will preferably want to know of the merchant's presence at point of origin 2, when the consumer is at points 11 or 13 the consumer will preferably want to know of the merchants at points of origin 4 or 6, respectively. When the consumer is at points 14 or 15, the consumer preferably wants to know of the merchants at points 2 and 4, or 4 and 6, respectively.

In this aspect, the merchant actively transmits it's presence to a consumer device upon receipt of an indication that the consumer's area of interest 12 includes the merchant's point of origin. In one embodiment, the merchant receives the indication of the consumer's area of interest 12 directly from the consumer device. In another embodiment, the merchant receives the indication of the consumer's area of interest indirectly from a position locating service. In yet another embodiment, the merchant receives an indication of the consumer's area of interest by directly detecting the consumer device using position detecting equipment. Thus, with respect to FIG. 1, when the consumer is at the first point of origin 10, the merchant's presence at point of origin 2 is automatically transmitted to the consumer, while if the consumer is at a second point of origin 11, 13, 14, or 15, the merchant's presence at points of origin 4 and/or 6 are transmitted to the consumer device.

FIG. 2 illustrates another embodiment of this aspect of the invention. In this embodiment, the merchant's points of origin 2, 4 and 6 are surrounded by a geographic service area 3, 5 or 7 defined by the merchant, within which the merchant desires to target consumers. The merchant's geographic service areas 3, 5, and 7 may be defined in a similar manner as the consumer's area of interest 12, i.e., by assignment, selection, geometric area or by geographic boundaries. The merchant's presence is transmitted to the consumer only if the consumer's defined area of interest 12 overlaps with the merchant's defined service area 3, 5 or 7. For purposes of illustration, FIG. 2 depicts the size of the consumers area of interest 12 as smaller than the merchant's service areas 3, 5, and 7, however, it will be understood that both these areas can be defined to suit the needs of either type of user.

In still other embodiments, the information content of the merchant's presence is in one form if the consumer is at a first distance from the merchant's point of origin, and in a second form that differs from the first form, if the consumer is at a second distance, that differs from the first distance. In these embodiments, the type of presence the merchant desires to transmit to the consumer is conditioned on the point of origin of the consumer 10 in addition to the consumer's area of interest 12. For example, in cases where the consumer indicates an area of interest 12 that is relatively large, such as within a city, or a point of origin 10, 11, 13, 14 or 15 at a distance that is relatively far from the merchants' points of origin 2, 4 or 6, the merchant may transmit a first type of generic message, such as “come and see us downtown”. In other cases, where the consumer indicates a point of origin 10, 11, 13, 14 or 15 that is relatively small and/or near the merchants' points of origin 2, 4, or 6, the merchant may transmit a different type of specific message, such as “We have a table opening now.”

In various embodiments, the indication of the consumer's point of origin 10, 11, 13, 14 or 15 and/or area of interest 12 is received in at least one of three non exclusive modes: a site mode, a sensing mode and a scan mode. In the site mode, the consumer transmits a single indication of a particular location, typically defined by an exact point of origin such as an address, and receives only information regarding merchants at that particular location. For example, if the consumer device transmits “101 Main Street, Small Town”, only merchants located at that building address in Small Town transmit their presence to the consumer device. The request mode is, therefore, limited to information for a single location.

In the sensing mode, the consumer device continuously or (periodically) transmits changing indications of the consumer's point of origin as the consumer moves from location to location. The sensing mode typically requires that the consumer device be equipped with position detection equipment, such as a GPS or other system that allows the consumer's location to be tracked. In the sensing mode, the consumer obtains continuously changing information regarding the merchant's presence, which corresponds to merchants located in proximity to the consumer's continuously changing positions.

In the scan mode, the consumer sends an indication of a point of origin and receives information concerning a plurality merchants at locations in proximity to that point of origin. The scan mode may be considered similar to the site mode, but with a larger defined area of interest 12. In certain embodiments, the scan mode is a default mode that operates with an initially defined area of interest 12. In other embodiments, the consumer may set a larger area of interest in order to obtain a greater amount of information or a smaller area of interest 12 to obtain less information.

A large number of variables affect whether a merchant desires to make a presence known to a consumer and whether the consumer desires to receive the merchant presence. There may, for example, be a very large number of merchants in proximity to the consumer's area of interest 12 in which the consumer has no interest. Accordingly, in various embodiments, consumers and merchants pre-select or otherwise define categories of goods or services sought and offered, respectively. In these embodiments, the merchant's presence is transmitted to the consumer only if the consumer's category of interest is the same or similar to the merchants category of goods/and or services. In some embodiments, an indication of the category of goods or services is received simultaneously with the indication of the consumer's area of interest. In other embodiments, the consumer's category of interest is pre-assigned by a service provider, selected from a list by the consumer, or defined by the consumer, for example, using keywords.

One embodiment of a selectable category is a “channel”. A channel operates as a filter that restricts transmission of data to information that meets predetermined categorical criteria. Channels may include one category of information or may include a combination of categories. For example, one category may be “movies,” another category may be “restaurants,” another category may be “mechanical services” and yet another category may be “gas stations”. The first two categories may be grouped on a channel entitled “night life” while the latter two may grouped on a channel entitled “automotive”. The consumer may select a channel to receive an indication only of merchant's offering goods and/or services in the specified categories or channels.

A similar example of a category is a “favorites list.” The consumer defines a list of particular categories of goods and services for which the consumer is most often interested. The defined categories are saved on the favorites list so that the consumer can limit receipt of transmission of information from merchants to those merchants offering goods and services defined on the consumer's favorites list.

In various embodiments, the use of categories is combined with the aforementioned modes of sending the indication of the consumer's location and of selecting the size of the area of interest 12 to provide the consumer with various levels of control over the information transmitted by the merchants. For example, the site mode is typically used in the absence of a category filter because a single location is likely to have few merchants associated therewith. The sense mode is typically used with a broad category filter or no filter, but with a relatively small area of interest so that the consumer may receive all available information from location to location. The scan mode is typically used with a narrow category filter and a relatively large area of interest to obtain information regarding most of the merchants within the category even if their location is somewhat more distant from the consumer's point of origin 10. Another level of control over information transmission is a switch, or more specifically, a switch command, that allows the consumer to activate or inactivate any or all transmissions of the merchant's presence at the consumer's will.

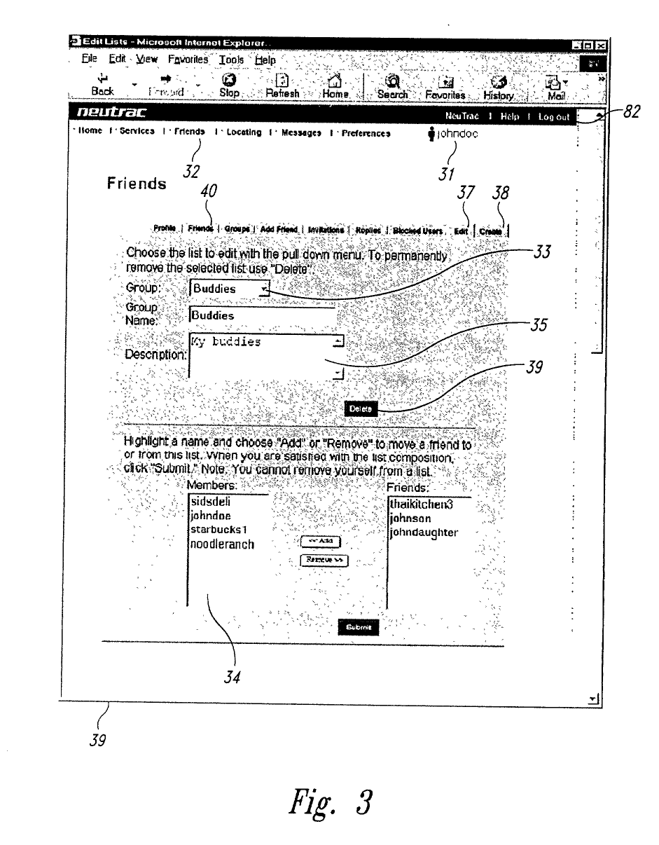

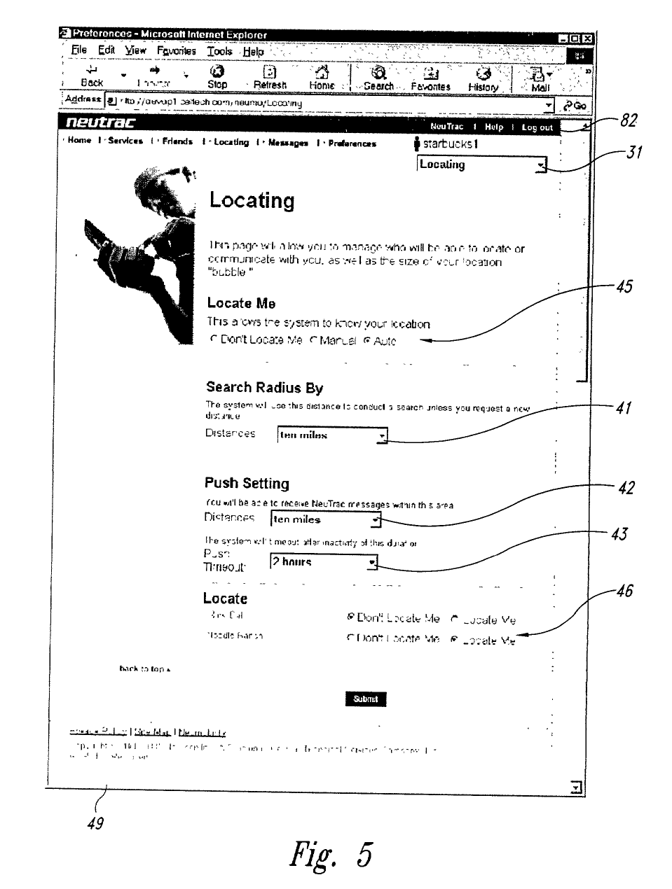

FIG. 3 illustrates an example of a consumer view of a plurality of merchants' presence transmitted to a consumer device in HTML format. The view is transmitted in a conventional Web layout window 80. Within the Web window 80 is a banner indicating the operator 82 of the presence server 30. A presence server 30 (See FIG. 5) has detected the presence of, or received an indication of the location of, a consumer device with a point of origin specified by GPS coordinates 84 that appear in a point of origin field 85. In response, the presence server 30 automatically transmits a list of a plurality of merchants 86, identified by the subject of goods and/or services 89 and the merchant creator's mark or name 90, which are those merchants located within a certain distance as listed in distance field 88. A plurality of detail buttons 92 are provided for each merchant's presence, which enable the consumer to select further information for any of the plurality of merchants 86. Upon activation of a detail button, a detail window 94 is displayed that includes a name for a selected merchant 96 with a description of the merchant's goods or services 98. Also included in the detail window 94 are merchant specified option buttons 100 and 102, that link to an audio file (or other media) 100 or an electronic coupon 102, which provides further information regarding the selected merchant 96 and its offers. Electronic coupons are described in more detail in co-pending application No. ______. Keywords listed by the merchant, the merchant's URL address and other merchant information are displayed in the attached text fields 104. Web link buttons 106 are also displayed, to permit the consumer to link to the merchant's Web site, merchant applications 70, or a mapping system 68 (see FIG. 5), which automatically calculates and displays a map and/or directions to the merchant's point of origin.

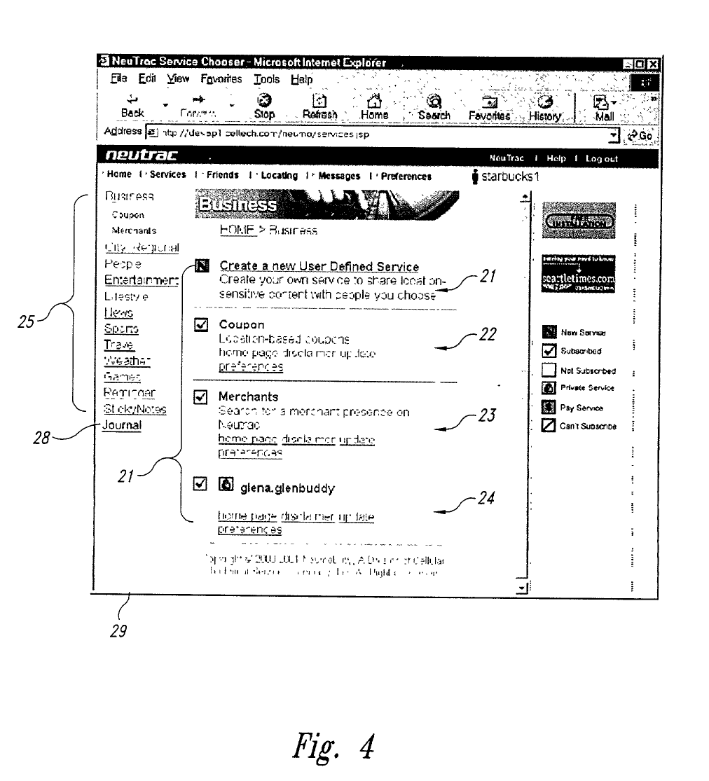

FIG. 4 illustrates an example of a display transmitted to a consumer device that combines the scan mode with category criteria to limit the display of the merchant's presence to specified types of merchants defined by the consumer. The detected point of origin of the consumer device or the point of origin otherwise defined by the consumer is entered optionally as an address 106 or as GPS coordinates 84. The consumer is given the option to retrieve a list of preselected points of origin using a location field list 108, to save a default point of origin using a “my location” button 110, or to delete preselected points of origin using a delete button 112. The consumer performs the scan using, for example, a keyword field 114 and/or a category field 116. Various optional services provided by certain types of merchants linked to the presence server may also be selected using a service field list 118 or a merchant defined filter 119. The user may also be given the option to specify certain types of merchant information specified in a Boolean type list 120 or by the creator or merchant name field 90. In response to the scan, the mapping system 68 is accessed to display a location map 124 that includes an indication of the presence and location of a plurality of merchants 126 in the selected categories. An optional “locate me” button 128 enables the user to also display an indication of the consumer's point of origin on the same location map 124.

Transmission of the merchant presence does not await a search by the consumer. Rather, the merchant's presence is actively “pushed” to the consumer based on the indicated location received from the consumer device without the need for the consumer to search. For example, as illustrated in FIG. 4, the consumer receives the list 86 of a plurality of merchants 88 solely based on the consumer's location rather than a search. As the indicated location of the consumer changes, so does the list 86 of merchant's having a presence transmitted to the consumer device. To illustrate by example, as a consumer strolls down a city block the precise coordinates of the consumer's point of origin changes. If the consumer device is configured with an area of interest defined at 500 feet, is set in the scan mode or the sensing mode, then the merchant presence list 86 displayed at one end of the block will be different from the merchant presence list 86 displayed at the opposite end of the block—without requiring intervention by the consumer.

Another aspect of the present invention is a system for providing the merchant's presence to a consumer whenever the merchant receives an indication from the consumer device that the consumer is near the merchant's location. FIG. 5A is a block diagram of a basic system 18 according to this aspect. The basic system 18 includes various pieces of software and hardware that provide the merchant presence to the consumer based on receiving an indication of the consumer's location. The consumer interacts with the merchant through the consumer device 20. The consumer device 20 may be any communications device equipped with electronics that allow the consumer to interact with the merchant, such as a wired device or a wireless device. Suitable consumer devices include, but are not limited to, mobile telephones, mobile computers, personal desk top computers connected to the World Wide Web, personal digital assistants, BLACKBERRIES and the like.

The basic system 18 includes a presence server 30 that reveals the merchant presence to the consumer. The presence server 30 includes a device interface 35 that structures the merchant's presence into a format and/or uses a protocol recognized by the consumer device 20 when the presence server 30 receives a signal indicating that the consumer's location is near the merchant's location. The presence server 30 also includes a communication port 32 for transmitting the merchant's presence to the consumer device 20 in the appropriate format or protocol. The communication port 32 may be configured with a wireless or wired communication line.

The presence server 30 selects the appropriate protocol or format for the device interface 35 by receiving an indication of the type of consumer device 20. The indication of the type of consumer device may be sent de novo from the consumer device 20 along with the indication of the consumer's location, or may be “looked-up” on a subscriber list that identifies the consumer, the consumer device 20 and appropriate format or protocol. Such a list may be contributed to by the consumer directly using configuration parameters applied when the consumer subscribes to a service for contacting the presence server 30. Alternatively, the list may be obtained from another service provider, for example, a mobile communication service or LSP that equips the consumer with the consumer device 20.

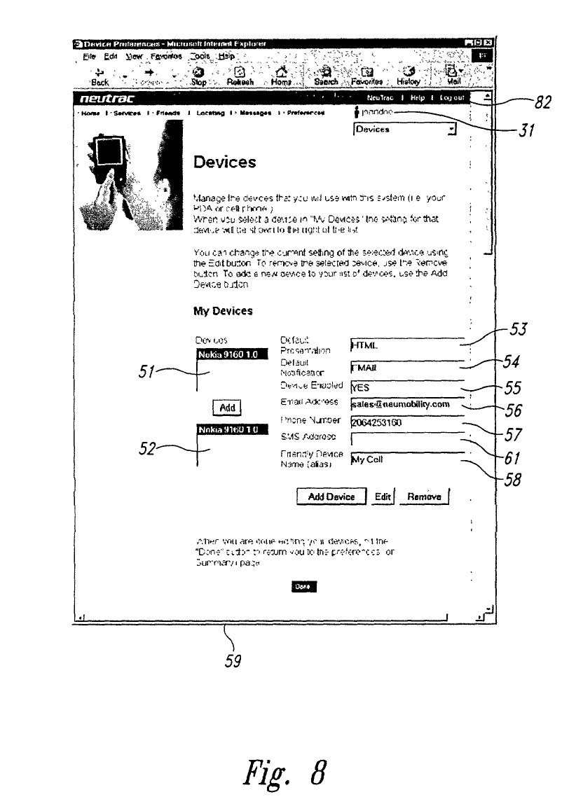

FIG. 8 illustrates a Device Preferences GUI 59 that allows the identified user 31 to configure their own consumer device 20 for receiving presentations of information content in a protocol and or format that is compatible with their particular consumer device 20. The Device Preferences GUI 59 includes a list of selected consumer devices 51 that the identified user 31 may use from time to time. These are typically selected from a master selection list 52 that preferably includes a name of all known types of consumer devices 20 with predefined formats and/or protocols. The identified user 31 is able to set a default format for presentation of different types of information. For example, a default presentation field 53 determines the format the consumer prefers to receive presentation information while a default message field 54 determines the preferred format for receiving short messages. The Device Preferences GUI 59 also includes an enable button 55 to selectively enable communication with the selected device 51. An E-mail field 56 is provided for the identified user 31 to enter a preferred E-mail address, a telephone field 57 is provided for entry of a telephone number for the device, a device nickname field 58 is provided to allow the identified user 31 to apply different names to similar devices, and an SMS field 59 is provided for entry of a path for SMS voice messages.

As mentioned, the device interface 35 selectively communicates to the consumer device 20 through the communication port 32 using the appropriate format and/or protocol for the type of consumer device 20. For example, if the consumer device 20 can interpret hypertext markup language (HTML), the device interface 35 may send information in the form of HTML pages to the consumer device 20. User I/O compatibility is diverse and includes standard Web access, voice input through an IVR system, SMS messaging, E-mail, and other types of messaging technology. Accordingly, the device interface 35 is configured to communicate to the consumer using a variety of techniques including, but not limited to Wireless Application Protocol, Wireless Metal Language (WML), Voice eXtensible Markup Language pages (VoiceXML), Short Message Service (SMS) or E-mail. Depending on consumer device 20 capability and configuration, the presence server 30 may be acting as transmitter to the consumer, receiver from the consumer, or both.

The presence server 30 also includes a storage medium 40 and a merchant interface 41 that enable the merchant to enter and store information concerning the merchant's presence, such as geographic point of origin, service area, name, category of goods and services, business mark, description of the business and the like. The storage medium may also store subscriber information regarding individual consumers. In various optional embodiments, the merchant interface also enables the merchant to define a Web site, define a Web page, define an E-mail, define keywords, define an audio file, define a video file, and/or define forms for interacting with the consumer. The storage medium 40 typically stores a database 69 of merchant and/or consumer information.

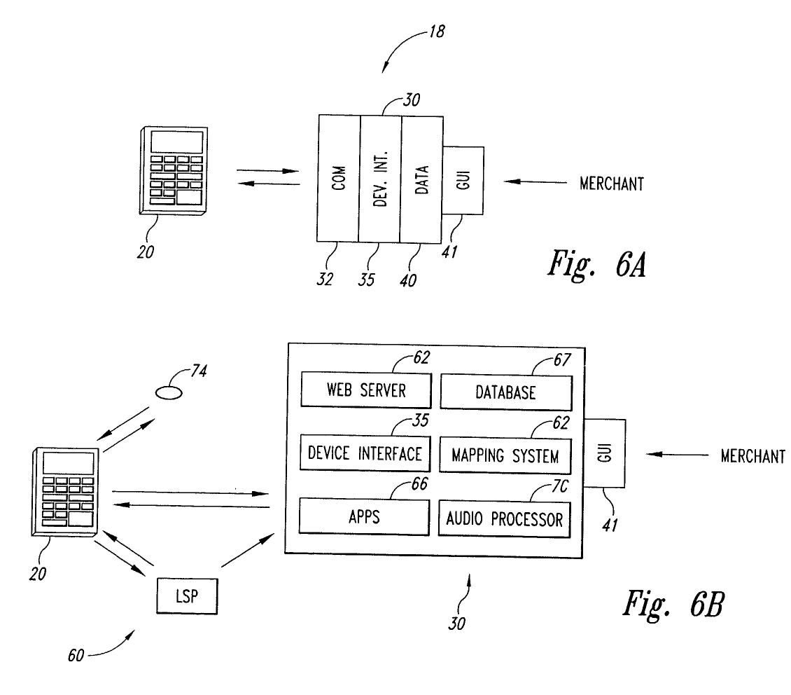

FIG. 6 illustrates one embodiment of the merchant interface 41, which includes a graphical user interface (GUI) 38 for entering or specifying a location of data for the merchant's Web based URL 43, E-mail address 44, telephone number 45, business category 46, summary identification message 47, promotional message 48, and business mark 49. The merchant's location in terms of geographic point of origin 2, 4, or 6 and/or service area 3, 5 is defined in another form or sub form of the graphical user interface (not illustrated). Optionally, the GUI 38 includes a demographic statistics link 50 that enables the merchant to track the activity and/or identity of consumers that receive a transmission of the merchant's presence over time.

The merchant optionally works with the setup page/wizard to create/deploy their presence and the consumer is presented with a consumer view of this presence. Merchants can log on to their personalized system account and navigate to their own customized location-based presence. This presence may be initially populated with personalization data taken from their own user accounts. From then on, the merchant can come back to their setup page/wizard and modify the various data associated with its presence. Thus, the merchant presence is not only actively communicated by the merchant, it is a “live” presence. Changes are immediately reflected into the overall system.

Although the system has the capability to import (through various interfaces) merchant data from existing sources such as directories and directory services, the system allows merchants to independently subscribe to, and take full control of their presence. The overall accuracy of the system (both spatial and content) is therefore inherently more accurate than existing technologies that employ for example “spiders” that almost blindly attempt to index various merchant locations from existing Web pages using fields for the merchant's address or zip code.

FIG. 5B illustrates an expanded system 60 that includes various components for certain embodiments of the presence server 30. This embodiment of the system 60 includes a Web server 62 that serves HTML pages. The merchant interface 41 of the presence server 30 may be implemented to transmit Web pages to the consumer device 20 thorough the device interface 35 if the consumer device 20 can interpret HTML pages. The expanded system 60 include a VoiceXML server 64 that provides Voice eXtensible Markup Language pages when the consumer device 20 is configured to receive and interpret VoiceXML pages. The expanded system 60 may also include a number of merchant applications 66. The merchant applications 66 include programs that enable the merchant to tailor the merchant presence to merchant defined specifications, including the information necessary to define the merchant presence as well as programs for conducting business with the consumer The merchant applications 66 may include, for example, demographic statistics and other tracking features that enable the merchant to keep records of contact with consumers. The merchant applications 66 may also include various applications implemented by the merchant for doing business, for example for taking orders, making reservations, accepting forms of payment and the like.

The presence server 30 of the expanded system 60 is configured with a number of other sub-systems and/or applications that enhance the merchant presence. These other systems include, for example, the mapping system 68. The mapping system 68 provides the merchant point of origin, address and routing instructions to the consumer based on the received indication of the consumer's location. It may also be used by the consumer to map the location of a plurality of merchants within the consumer's area of interest as shown in FIG. 4. The presence server 30 also includes an audio processing application 70 that allows processing of audio information for voice recognition, voice to text, or text to voice conversions. When configured with the device interface 35, the audio processing application 70 allows transmission of messages a broad variety of consumer devices 20, which may be as basic as a plain old telephone system (POTS) or as sophisticated cellular phone with digital personal assistant technology.

The expanded system 60 typically includes various databases 69 to keep information regarding the plurality of merchants consumers. In one embodiment, the database 69 is implemented using Oracle, but any suitable database technology can be used, such as Microsoft SQL server. The database 69 and respective application software may be used to create systems for storing the “location” and “content” merchant information. In addition these databases 69 may provide subscriber subsystems, billing subsystems, or administration subsystems to assist in commercial deployment of the system 60 to serve a variety of users and markets.

The consumer device 20 depicted in the expanded system 60 may be configured with a positioning application or position determining equipment (PDE) 72 that enables precise determination of the point of origin of the consumer device 20 using positioning coordinates determined by a location service provider (LSP) 71, a mobile positioning center (MPC) or by direct communication with a global positioning satellite 74. The presence server 30 is configured to receive information as to whether a particular consumer device 20 includes the PDE 72, and if so, what type. The presence server 30 may then utilize the positioning coordinates provided from the PDE 72 directly from the consumer device 20 to automatically detect the consumer's point of origin as it changes. Alternatively, the presence server 30 may receive positioning coordinates from the consumer device 20 indirectly from the LSP 71 or MPC. Another type of positioning is “manual” positioning where the user sets their position through normal data entry including latitude and longitude, address, cross street, zip, or by selecting location “bookmarks” or through selection of location history.

In one embodiment, the presence server 30 only receives the positioning coordinates if the user first obtains the signal independently and then authorizes its transmission to the presence server 30. In other embodiments, such as in the sensing mode, the consumer's location is tracked and the positioning coordinates are transmitted to the presence server 30 automatically. In these embodiments, the consumers position is tracked as the consumer moves. In still other embodiments, the consumer may store the most recent indication of the consumer's coordinates or the consumer's home position, and receive merchant information for that position whenever the presence server 30 receives an indication of that position.

The embodiments of the present invention enable merchants to easily create, deploy, and sustain a location specific wireless and non-wireless presence. The merchants can do so with or without assistance from a third party agent other than the provider of the presence server 30 and that implements the methods disclosed herein. However, other third party providers such as ISPs LSPs and MPCs and the like may also utilize the system on behalf of their clients.

The system 60 does not require significant design talent on the part of its users, other than operating a browser and filling out forms (e.g., formal web experience). Therefore, the system 60 is available for use by a broad base of merchants and consumers. Some of these merchants may have expertise in web presence and others may not. The merchant presence captures the merchant information within a system application database 69, which also supports links to external sources. Merchants that already have a home page (wireless or non-wireless) can link these external sources to this location-based presence, thus, in fact automatically making their existing non-location enabled presence, location sensitive.

In a more general aspect of the invention, the presence server 30 and transmission of the merchant's presence to a consumer device 20 based on location is part of an overall Application that allows a variety of users types to find, detect, track and interact through location-aware technology. The Application has aspects that extend to any location-aware reception and transmission of information.

In this more general aspect, any space in the physical world can be “mapped” to a defined location. For each location, a user of the system may create associations (e.g., a presence) that is stored on electronic medium in the virtual world. Any given location in space may have an untold number of virtual records or “associations” therewith, including for example, attachments, links or other annotations connected to the location. The virtual presence associated with the physical location is accessed using any communication device equipped with location specific functions, for example, a cell phone, appliance, PDA or other computing resource. To facilitate understanding of this broader aspect, it is helpful to further define certain terms to reach a common understanding of the meaning thereof:

A “location” is a reference to a feature in the physical and virtual world that has a number of dimensions:

One physical dimension of location is “origin” or “point of origin” which has been described previously herein to include at least one of an address or coordinates such as latitude and longitude that define a reference point for the center of the location. Any unique address represented in the conventional form by number, street, city, state and country has a corresponding unique representation in global positioning coordinates, and thus all points of origin are unique although they may have numerous forms of representation.

Another physical dimension of location is “size,” which is a generic term for the area of interest (or service area) defined by a user as previously described. Typically, the size of a location may simplistically be defined by an ellipse, rectangle or other geometric boundary that encompasses an area. A radius, length, or other unit of measure of distance can then be used to describe the size of the location based on a reference to its origin and geometric boundary.

One virtual dimension of location is “Context” which is defined by a system operator or user to characterize the attributes of access and/or electronic interactions allowed between users and locations. Information, applications, or behaviors of locations may be different depending on the context that is applied to it. For example, a given location may have information that may be characterized as private, public, public moderated, or commercial. In this example “private” would classify information that is only accessible by a particular user or set of users, “public” would be accessible to all, “public moderated” would be managed by a third party, and “commercial” would be managed by a commercial enterprise. Other example of Context include those used in URL addresses on the World Wide Web, such as “gov” or “edu.”

Another virtual dimension of location is “Category”, which describes topic filters applied to the location under a particular context. A category includes, for example, user defined types and subtypes of information related to the location. One example of implementation of a category is a “channel” as previously discussed. For example, a channel may include specific category sets like Restaurant, Historical, Crime, Geology, Graffiti, Travel, and the like, or may include larger sets like Leisure that include several subsets.

Another virtual dimension is “meta data” or keywords, which act as both a structured and freeform description pertinent to location. One example of this implementation could be specifying a restaurant category AND keywords such as “vegetarian”, “kids” or “fish”.

Another virtual dimension of location is “Time” Any location may have a sense of time that is applied to attachments and other associations as a time stamp. Users access the location in the time domain as well as the physical domain.

Yet another virtual dimension of location is “Behavior,” which relates to how the association or attachment of information is stored or communicated. Behavior may differ based on the user access device, the user, the Context, the Category, the Time, etc. Behavior is typically implemented by program applications. Behavior examples include, but are not limited to, items like “notification,” “display,” “sound bite” and the like.

“Content” is the actual virtual information associated with location and stored on computer readable medium. Content can be anything, for example: text notes, SMS, WebPages, WAP, voice memos, sound, images and the like. Content can be stored by value or by reference. Locations can be absolute or regionalized into “views”. Behaviors can be created for locations and/or particular location views. In one aspect, content creation is provided to users on an ad hoc basis to facilitate ease of use, and self-propagation of content.

The Content of information associated with the location may also have various “Properties”. Example properties include, “type” which includes descriptive forms such as E-mail address, URL, audio file and the like. Another property of Content is “Persistence”, which determines how long the author or creator of the content desires their contribution to persist. Yet another property is “Security,” which is a user definable attribute of access. Although some level of security is provided by the Context, particular users may apply different levels of Security to their information content.

Another property of Content is “Selected Area.” As mentioned above, a location includes a defined area of interest or service area, however, the user may wish to select a smaller or larger area of interest (radius) for particular purposes based on particular conditions. For example, a user may select a large area of interest when accessing or transmitting location information about a city, or select a smaller area when accessing or transmitting location information about a street. Different Content may be transmitted depending on the Selected Area.

“Content Behavior” is a property similar to the behavior dimension of location, but associated with content. For example, when a piece of content is accessed there may be a prescribed behavior associated with the access. This could be as simple as registering how many times the content is accessed, by whom, when, etc., or as complex as executing a series complex scripts or program applications.

In typical embodiments, this system interacts with locations by interfacing with existing LSPs, MPCs or other position tracking services. Suitable commercial LSPs and MPCs are exemplified by companies such as SignalSoft, Cell-loc, and Ericcson. For example, Signal Soft implements a mobile location service with their LocationManager product. Such products provide the locating hardware and software needed to communicate the positioning coordinates and other “where” based functions required for large system implementation. The LSP or MPC provides interoperability between service regions and disparate equipment and technology providers. The LSP or MPC may also provide application developers with a common API with which to develop location specific applications.

The Application provides a standardized method of interacting with wireless resources to provide consistent usability across the Application “System”. The infrastructure easily supports advanced functionality through the inclusion of location and content external reference calls based on user actions. User actions may include both location and content events. It provides an overall framework that supports by design (out of the box) most of the “informational” types of “applications” that would otherwise require discrete applications to be developed and deployed. The Application grows with contributors and users and does not need massive content initialization. The Application may be used ad hoc but is also amenable to structure and commercialization because it provides “just enough” organization to combine Location, Content, and Time within a common controllable application.

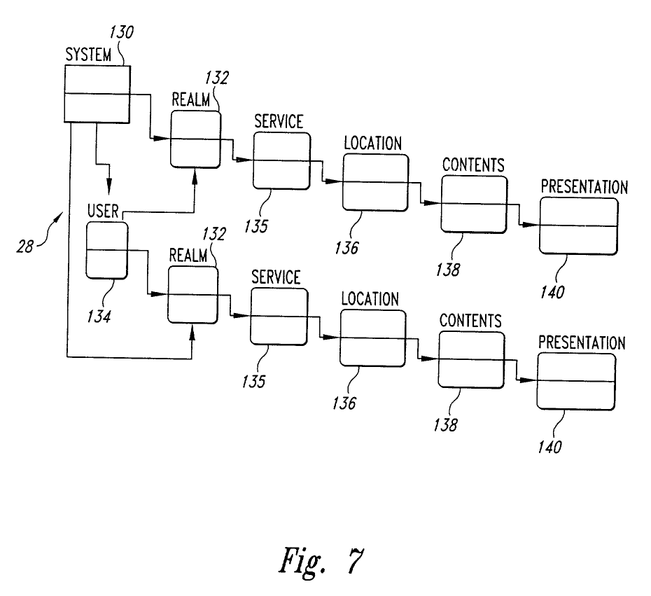

FIG. 7 is a schematic overview of one embodiment for organization of the Application 128 that underpins a network of presence servers 30 described herein. The Application 128 includes a central database/application herein designated the “System” 130 and ‘n’ number of distributed databases/applications herein designated a “Realm” 132. The System 130 is a centralized service that links Realms with Users 134. The System database may be deployed at a single centrally located geographical site or may be distributed through a number of sites by linking a network of servers. The System 130 applies application and business rules to the interaction of Users and Realms.

The Realms 134 are distributed applications and databases. Realms 134 interface with the System 130 to manage User 134 activity and accounting, User rooming events, and other system wide interactions. The Realm 132 includes Service applications 135, that in turn organize and operate on Location specific 136 information for the Users 134, the Content 138 of the location information, and the Presentation objects 140 needed to present the Content 138 to the Users 134. Hence, the primary function of the Realm 132 is to manage the list of Location objects within each Realm. A Realm 132 administrator is constrained to administration of Locations within its respective Realm.

User 134 accounts are created and managed by a system object. User objects on the System 130 capture the User's 134 identification, account information for billing, telecommunication details such as type of communication device, telephone number, communication protocol, format, device type or model, and positioning capability. Other User 134 specific information managed by the System 130 includes, security information, preferences, and other details specific for individual users such as “buddy lists.” A “buddy list” is a user defined list of other Users with whom User defined location specific information is shared.

The location objects implement the data and behavior of geographical entities. Locations 136 are added to a Realm 132 databases based on Realm logic and a creation event. When a Realm 132 is initially created, there are no Locations 136. Locations 136 are initialized by the creator of the Realm 132 or through a creation event of the Users 134. Locations 136 include points of origin, areas of interest, service areas, locations size and the like. All locations contain Content 138. Table 1 illustrates one example of a Location 136 structure.

TABLE 1
Example Location Structure

| Item | Detail |
|---|---|
| Latitude | geo-location |
| Longitude | geo-location |
| Altitude | geo-location |
| Radius | Optional definition of how “big” this |
| | location is. Describes a circle from the |
| | origin points of lat, long. |
| Rectangle | Optional definition of how “big” this |
| | location is. Describes a rectangle from |
| | reference of the lat, long. |
| ServiceList | Reference to a list of Services. |
| OnEnter | Reference to an executable to run when a |
| | User enters this location. |
| OnIn | Reference to an executable that will run |
| | when the User stays within the location area |
| | for a specified period of time. |
| OnExit | Reference to an executable that will be run |
| | when the User exits from this location. |
| Rating | Accumulates the overall rating of this |
| | Location. A summary of all ratings. |

The size of a Location 136 is determined by the resolution capacity of the positioning technology and of this application. If the location determining equipment or LSP can only provide a resolution of, for example, 300 feet then the user's position will fall somewhere within that 300 foot area. If a user were then to request information within 200 feet, the inability of the LSP to resolve to 200 feet will result in a default to the highest resolution possible, i.e. 300 feet.

The size may be User selected, System 130 selected, or determined by the type of equipment used by the User 134. For example, a LSP servicing a given type of User 134 with a given type of PDE may return a default “size” that will include an origin and the approximated resolution e.g. an origin with a radius of uncertainty, which may, for example, be expressed as plus or minus some distance unit or in some other form. This resolution and therefore “size” will change if equipment is swapped out with higher or lower resolution technology or as upgrades to the System 130 occur. This size factor determines if a User 134 is in or out of a defined Location 136.

Locations 136 may have one or many Services 135 associated with them. The Services 135 provide utilities and behaviors that allow the Users 134 to interact with the Content 138 and applications associated therewith. Services 135 are primarily identified by their Context and topic. When Users 134 subscribe to the Service 135, the User's 134 reference is attached to the service. A reference to this user is placed within a service personalization database. The user is now part of that service “community”. Services 135 are organized by the Context in which they will be used. Table 4 illustrates some features of various service 135 items.

TABLE 4
Service Definition

| Item | Detail |
|---|---|
| Context | Scope, security, domain! |
| Topic | Subject matter or function |
| UserList | List of Users who are subscribed to this service |
| OnSubscribe | Database field that holds a path to an executable action to |
| | take when someone subscribes to this service. |
| | This path/executable may point to any special |
| | requirements or set up that the user is required to make. |
| OnUnsubscribe | Database field that holds a path to an executable action to |
| | take when someone is actively using this service. |
| OnActive | Database field that holds a path to an executable action to |
| | take when someone is actively using this service. |
| OnInactive | Database field that holds a path to an executable action to |
| | take when someone is actively using this service. |
| Special | Special information that is unique to this service. |

The behavior fields: OnSubscribe, OnUnSubscribe, OnActive, OnInactive fields are set to the appropriate behaviors, e.g., Executables, scripts or other programmatic actions callbacks of this new service. Each of these will perform some Service 135 specific function. OnSubscribe may validate billing and perform other subscription tasks. OnActive indicates to the Application that a User 134 is currently actively using the System.

Services 135 can draw on a preference interface that allows Services 135 to dynamically add preference pages to a User list of preferences. The user object would therefore include service management in its portfolio of capabilities. Users 134 may access their personalized setup which will include device type/model, preferences for messaging, selection of services, and other preferences which will assist them in modifying the behavior of their experience.

The Users 134 of the System 130 operate within specified Context provided by the System 130. Context in many ways is similar to “domain” as used with respect to the organization of the World Wide Web. In order to prevent confusion and more clearly denote functional differences, the term “Context” is applied to the location specific Content using the methods and systems disclosed herein. The Context of a Content 138 item describes how that Content is accessed and controlled. Context supports security and exclusivity.

Available Contexts are presented to Users 134 and are managed through the user account setup process. Table 2 illustrates example Contexts that may be setup by various types of Users 134 and the type of access privileges provided therewith.

TABLE 2
Example Contexts

| | Access | | |
|---|---|---|---|
| Context | Read | Write | Admin (R/W/D) |
| pub | User | User | |
| pub_moderated | User | User | pub.topic.admin |
| priv | User | User | User |
| priv_moderated | User.BuddyList | User.BuddyList | User |
| com | User | com.topic.admin | com.topic.admin |
| com_moderated | com.topic.BuddyList | com.topic.BuddyList | com.topic.admin |
| com_private | com.topic.BuddyList | | com.topic.admin |
| gov | User | User | gov.topic.admin |
| gov_moderated | gov.topic.BuddyList | gov.topic.BuddyList | gov.topic.admin |
| gov_private | gov.topic.BuddyList | | gov.topic.admin |
| edu | User | User | edu.topic.admin |
| edu_moderated | edu.topic.BuddyList | edu.topic.BuddyList | edu.topic.admin |
| edu_private | edu.topic.BuddyList | | edu.topic.admin |

This initial set of Context’ are suitable to cover public, personal, commercial, government, and educational organizations. The use of “BuddyList” pertains to a list of users that may be set up by a Context administrator or by the User.

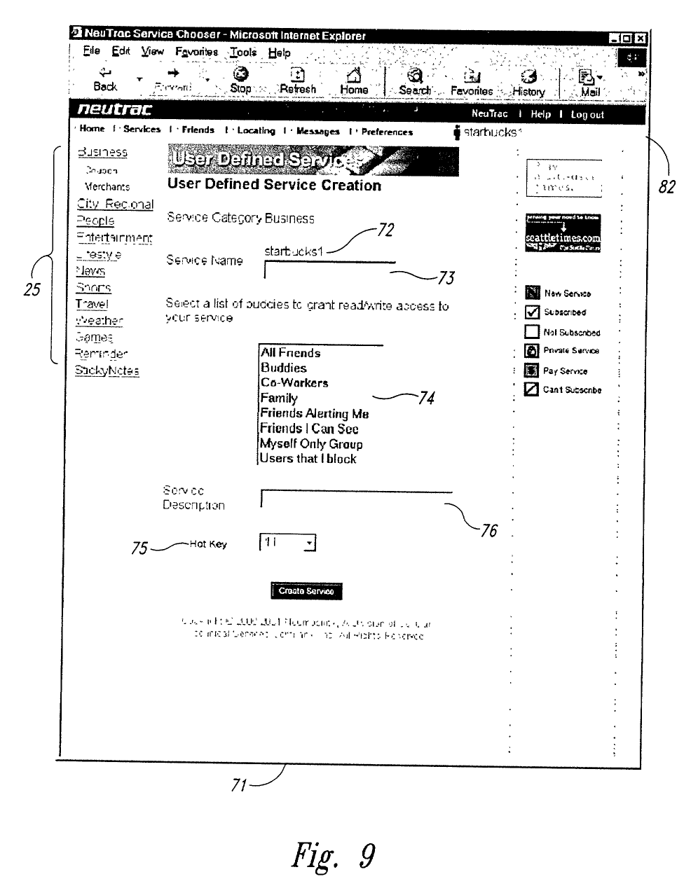

FIG. 9 illustrates a Private Service GUI 71 that allows users to establish a private moderated Context for other users that will have access to the location-specific content established by a particular user. Typically, a business user will use the Private Service GUI 71 to create a private moderated context to enable only certain types of other users, for example, employees, business associate, vendors and the like, to access information content concerning the business. The Private Service GUI includes a service category field 72 that defines the category for the service and a service name field 73 that defines a name for the particular business user. A group list field 74 is provided to allow users to set up specified lists of other users analogous to a buddy list. A hot key option 75 is provided to enable users to instantly access information content from the private service by use of a single entry key from the consumer device 20. A service description field 76 is also included to allow the business user to provide a short description of the groups and or functions provided by the private service.

“Topic” refers to categories of information that are organized by related content or subject matter. When Context and Topic are combined, they may function like “channels” which limit the type of content transmitted to users 134. Topical Content may vary depending on the Context’ with which they are accessed. For example, a Topic called “restaurant” within the Context of “com” (commercial) will access Content that has been generated by restaurant proprietors within a selected Location. A Context of “pub” under the same Topic and Location will access Content that has been generated by the public regarding restaurants in the Location. Realms 132 are preferably deployed with a “standard” set of Topics and additional Topics may be added. Table 3 illustrates example Topics and the Content provided therein as a function of Context.

TABLE 3
Example Topics

| Topics | Detail |
|---|---|
| Restaurants | Of course influenced by Context: |
| | Com.restaurants will provide restaurants with an avenue to |
| | promote and communicate with consumers in the location |
| | area. |
| | Pub.restaurants will provide the public with an avenue to |
| | communicate about a restaurant at the current location. |
| | Pub_moderated restaurants will provide the user with |
| | access to a moderated public point of view about the |
| | restaurant. The moderator of this could be a food critic for |
| | example. |
| | Com.private would provide the restaurant with an avenue to |
| | communicate with restaurant employees or suppliers, |
| | etc . . . |
| Traffic | Com.traffic will provide an avenue for commercial traffic |
| | information. This could allow various commercial services |
| | to supply information/apps about their services. |
| | Com_moderated traffic would provide a commercial |
| | vehicle for information and application use by users. |
| | Traffic value added services could operate in this |
| | “channel”. |
| | Pub.traffic would provide an avenue for public |
| | communication of traffic in that location. |
| | Gov.traffic would provide an avenue for government in |
| | content. |

Content 138 may be described through a system of Context/Topic pairs. Context broadly describes the accessibility and control of a Topic. Topic describes the content theme. For example Content within the topic Public.Restaurants describes Content which is not moderated, is open to the public, which deals with the subject of “restaurants” at a Location. Table 5 illustrates example content structures.

TABLE 5
Example Content Structures

| Item | Detail |
|---|---|
| Presentation | Defines the type of content by presentation. Content type |
| | could be text, SMS, URL, URL-HDML, URL- |
| | TinyHTML, URL-WML, Voice, Picture, etc . . . |
| Date | Date that content was created |
| Time | Time that content was created |
| Author | The User who submitted the content |
| OnAccess | Reference to external executable to run when this content |
| | is accessed by a User |
| OnDelete | Reference to an external executable to run when a User |
| | deletes this content. |
| OnEdit | Reference to an external executable to run when a User |
| | edits this content. |
| Rating | A User based rating score applied to this content. E.g., 1- |
| | 10 based on system rating system. |
| Data | Reference to actual content data. |

Content 138 is preferably ordered by both System 130 preferences and by User 134 preferences. Ordering of some topics may be by “nearest” or by “best” or other characteristic.

The Presentation 140 of Content 138 will vary widely depending on device. Robust presentation objects are used to implement this through the device interface. Presentation objects may also be constructed to support multiple Presentations 140 from a single Content source 138 based on user preferences or equipment. For example, the Presentation 140 of the same Content 138 could be text for one user 134, voice mail for a different user or an HTML page for a third user. In addition the User 134 may have multiple capacities for receiving Presentations 140 of Content 138 and may change the preferred type of Presentation 140 from time to time. A default type of presentation is optionally stored in a user preference file. One advantage of the separation of Presentation 140 from Content 138 is that this permits flexibility in the design of the System 130 to respond to changes in technologies and in device capability or performance.

The following Examples illustrate various features, services or other aspects of the invention that may be implemented in various embodiments using the systems and methods described herein.

### EXAMPLE I

### Traffic Information

A user accesses a presence server 30, enters his or her work address as a point of origin, selects a channel designated “com.traffic ” from a PDA. The user receives a map displaying a plurality of highways and thoroughfares surrounding the point of origin and receives up to date reports on the traffic on the various routes provided by a real time traffic service. The user then activates a position determining GPS device configured with the PDA to obtain and transmit the users position. As the user travels down a selected route the GPS coordinates change and are transmitted to a plurality of receiver locations along the route, which in turn transmit updated traffic maps and reports at each location.

In this system the traffic application may be executed from either within the processing environment of the System 130 or externally from the traffic information provider's site. The Application may, for example, acquire a real time traffic feed from a government agency such as the Department of Transportation, or from a commercial provider. This information would be parsed and stored for the various locations along known traffic routes.

In an alternative procedure, the user proceeds down the route with a mobile phone configured with position determining equipment activated to transmit the consumer's position. The user had previously configured the mobile device to receive traffic route information. When the consumer's position is detected at a location along the route with updated traffic information, the consumer's cell phone is dialed by an automated computer system and a voice message is transmitted to the consumer regarding an accident has occurred near that location.

The user's preference for alerts and format thereof are set through account management through the system application. The System application places corresponding traffic alert content in the respective private.traffic Context for that user. Presentation of this Content is via the associated presentation object.

### EXAMPLE II

### Location Touring

Government agencies, and/or commercial enterprises create information content regarding various attractions and amenities available in a defined geographic area, such as a city. The content is attached to locations within the city that are stored on a database operated in the context of a commerical.tours service.

When a user accesses this service, for example, through a mobile communication device, the service executes an application script contained in the OnSubscribe field in the Service data table. An OnSubscribe handler then prompts the user to accept a charge for this service that will be placed on their mobile service carrier bill for the user. If the user accepts the charge the service is enabled for that user.

The user activates their mobile communication device e.g. a cell phone and proceeds with a physical tour of the geographic area. As the user navigates from location to location on the tour, the Content specific for different location on the tour is presented to the user's device as per the user's preferences, i.e., through a Voice tour, SMS messages or other format. The user may opt to manually send location information for each site that is reached by entering an address or street intersection, may have the user's location automatically sent to the service from a LSP or MPC as the user's position is tracked, or may obtain GPS coordinates for each location and then transmit that information to the service when desired. The user may request a route for a preselected tour, or make the tour extemporaneously. Optionally, the user may select certain channels within the tour, for example, a historical channel, that sends historical information regarding various locations in the vicinity of the users position.

### EXAMPLE III

### Electronic Coupons

Retail locations create an electronic coupon message as Content for their location under a service such as retail.coupons within the System. A user that accesses this service and that comes to a location in the vicinity of the business will be sent the coupon message automatically and in the users preferred format for their communication device.

### EXAMPLE IV

### Auto Toll

A commuter user routinely passes through a toll point, ferry, train or other transport service that requires a toll for use. The transport service establishes locations on the System specific for each location where a toll is required. The service may be organized under a category or channel denominated, for example, as Washington.tolls. The user activates the Washington.tolls service on a mobile positioning and communication device and then drives by a particular toll location. When the user enters the toll location, an indication of the user's presence is received from the device at the toll location, and an OnEnter event is executed that transmits the driver's license plate, identifying information and an electronic payment script that executes an electronic debit from an account owned by the user, to the toll service.

### EXAMPLE V

### Family Archive

A father and his sons are out mountain biking and come across an outstanding view where they eat lunch and talk about life. To mark this occasion and moment the father pulls out his cell phone and he and his sons enter a voice message that is stored with an indication of the particular geographic location on a private class and sports channel service provided by the System 130. The System 130 automatically timestamps the messages and attaches it to the location with a default radius for area of interest applied to the location. Alternatively, the father stores a digital picture or some other record of the location on other media. There is now a record of this family trip attached to that particular physical location. On this trip there may have been many others associated records made at different locations along the way.

The location specific records are accessed in the comfort of the family home by contacting the System 130 via the World Wide Web when the family returns. The family can also use data-mining and presentation tool applications to display the entire trip and use other applications to add further information regarding the experience. Two summers later, the father and sons take the same trip again. This time, along the way, they access the system 130 in a sense mode, choosing the same Context and channel as the records were stored. As the family enters these “hot” locations they are presented with the messages that were left several years ago.

In this scenario, the father or sons could also have left public messages for others to discover, and could have accessed other's experiences with these locations by having the location information stored in a public or moderated public Context.

### EXAMPLE IV

### Restaurant Experience

A restaurant owner has a Web site on the World Wide Web. The owner places this Web reference (URL) along with location data into the System 130. When people in the area are attempting to sense any restaurant or the owner's restaurant in particular using a communication device, the presence server detects the presence of the device and the owner's Web page is transmitted to the potential customer in the consumer's preferred format. The chef may pick up a cellular phone that morning and enter today's specials via voice, text, or SMS message to the system. Potential patrons coming into that location will have an option to view the home page of the restaurant through a WAP, listen to today's specials through voice mail, or receive an SMS message on their device.

While in front of the restaurant the customer may access a public/Restaurant/Rating for that location. That public Context provides ratings tabulated from all previous entries members of the public (unmoderated), or from particular members of the public (moderated) which may, for example, be a food critic from the local newspaper. Concerned about how late it is and the safety of the area, the prospective customer could also obtain a public safety rating, or other information attached to that location 136 on the system 130.

While in the restaurant, the customer (who has an interest in architecture) notes the age and beauty of the restaurant. The customer then accesses a Public/History channel for that location and is presented with anecdotes or other information contributed by others who have visited that location having a similar interest. For information that is more regulated or packaged, the customer may access a moderated version of this channel for a more “textbook” view on the history of this location.

The patron may then wonder if they know who has eaten there before and if any messages were left. The patron then applies his “buddy list” filter on the public forums associated with this location and obtains several interesting and comical messages or stories left by the patron's friends and family who have visited this location.

### EXAMPLE VII

### Theatres

A user arrives in an unfamiliar city on a business trip and wants to go to a movie or concert, or the user remains at home but does not know what movies or concerts are playing in the city. The user accesses the System 130, enters his current point of origin, selects a channel designated “theaters” and is automatically sent a list of all concerts and movie theatres that fall within the user's default area of interest or radius. Alternatively, if the user's device is not equipped with a graphical display, a list can be obtained by voice or text messaging. The list is sorted by proximity to the user's point of origin starting with the nearest venue. The user may also access comments left by the public or individuals on the user's buddy list who've seen the movie. The user may also obtain location specific information about the theatre, the sound system, the popcorn, the seats and the like. The same concept can be applied to finding concerts. The user may also use more detailed searching and filtering to find, for example, the closest theatre with THX or Dolby Digital sound that's showing a specific movie at a specific time.

### EXAMPLE VIII

### Finding Persons with Mutual Interests

Various users define or otherwise categorize subject matter of personal interest (or profile) and list their name and contact information in association with a location 136 on the System 130. When one user sends an indication of a particular location, and has a preference filter or channel set to “personal interest”, the user receives a message that lists the name and contact information for the other users associated with that location that share that interest. The user may therefore meet unknown people in proximity to their location whose interests or profile matches the profile of the user.

In certain embodiments, location based personal interest channels may operate like a real-time personal ad. Users can arrange, for example, to meet fellow travelers with similar interests in a foreign country. In another example, users can arrange to companion with other mountain-bikers in a given area by posting a message saying for example, “female mountain biker seeks same for trip to Tiger Mountain at 11:00 this morning to share costs, casual rider who takes it easy, so no gung-ho types please.” Similarly, a message can be posted that will reach bikers in a specific location at a specific time if the user specifies the same. In an unrelated example, a user could advertise a ticket for sale at a location outside a crowded event and be contacted by people at the event who set up their profile to indicate they are interested in tickets, and/or are also located near the event.

Conventional dating through personal ads based on location is also possible. In a preferred practice, a user's actual address or personal contact information would not be disclosed automatically, but would merely provide sufficient information for follow-up messaging. Safeguards and so called “handshaking procedures” would be used to control who can contact who. For example, if users did not want to give out cell phone numbers, E-mail address and the like, a location based message center could be established to exchange initial correspondence.

### EXAMPLE IX

### Finding Nearest Participating Physicians in a Health Plan

A user has a health plan that lists 10 participating physicians within the user's area. Having no idea which one to see, the user accesses location information using a category filter called “health care providers” under a context designated as public or public moderated to obtain a list of doctors within that location and public reviews concerning the service of the physician or their institution.

### EXAMPLE X

### Graffiti

Some users desire to associate artistic expressions with particular locations in virtual form rather than with spray paint. Such users could create such expressions in electronic form and associate them with a location under a category topic designated as “graffiti” on the system 130. Other users interested in viewing the same can obtain graffiti for particular locations using the methods and systems disclosed herein.

### EXAMPLE XI

### Employment

Many jobs are location specific, or employers or employees may offer or desire jobs with location specific restraints. Employers could post location specific job descriptions, information about themselves or the job, and contact information for interested applicants. Conversely, job seekers within a given location could post their own resumes associated with their location. The systems and methods described herein are readily adaptable for locations specific job searching.

### EXAMPLE XII

### Simple Location Ratings

Posting and access of public or private reviews of particular locations has been described herein before. The system 130 and methods are also readily adaptable to attaching simple types of public ratings to particular locations. A service could be established that merely holds content that consists of a number between 1-10, “bad”, “good”, “great,” or number of stars. People can associate their personal rating with a location and the service would merely average the ratings.

Although various illustrative and specific embodiments have been illustrated and described herein, it will be appreciated by those of ordinary skill in the art that any arrangement, which is calculated to achieve the same purpose, may be substituted for the specific embodiments shown. This application is intended to cover any adaptations or variations of the present invention. It is to be understood that the above description is intended to be illustrative, and not restrictive. Combinations of the above embodiments and other embodiments will be apparent to those of skill in the art upon reviewing the above description. The scope of the invention includes any other applications in which the above structures and fabrication methods are used. Accordingly, the scope of the invention should only be determined with reference to the appended claims, along with the full scope of equivalents to which such claims are entitled.

1. A method for providing a merchant presence to a consumer, comprising:
receiving merchant information in an electronic medium that defines the merchant presence, the merchant information including a defined location for the merchant and a category of goods and/or services offered by the merchant;
receiving information from a consumer device that includes an indication of the consumer's location without specifying an active search for the merchant; and
if the indication of the consumer location overlaps with the defined location for the merchant, actively presenting the merchant presence to the consumer device in response to receiving the indication of the consumer's location.

2. The method of claim 1 wherein the indication of the consumer location includes a point of origin for the consumer and an area of interest defined by the consumer, and wherein the merchant presence is transmitted to the consumer device only if the merchant location is within the area of interest defined by the consumer.

3. The method of claim 2 wherein the area of interest is at least one of, assigned to the consumer by a service provider, selected by the consumer from a list, defined as a geographical boundary, and defined by a geometric form encompassing a defined distance from the point origin of the consumer.

4. The method of claim 1 wherein the defined location for the merchant includes a point of origin for the merchant and a service area defined by the merchant; and wherein the merchant presence is transmitted to the consumer device only if the if the indication of the consumer location is within the service area defined by the merchant.

5. The method of claim 4 wherein the defined location for the merchant is at least one of, assigned to the merchant by a service provider, selected by the merchant from a list, defined as a geographical boundary, and defined by a geometric form encompassing a defined distance from the point origin of the merchant.

6. The method claim 1, further including receiving an indication of a consumer's category of goods and services, and wherein the merchant presence is transmitted to the consumer device only if the consumer's category of goods and services overlaps with the merchant's category of goods and/or services.

7. The method of claim 6 wherein the category is determined from a list of keywords that describe the business of the merchant.

8. The method of claim 1 wherein receiving the indication of the consumer location includes receiving geographic positioning coordinates for the consumer device.

9. The method of claim 8 wherein the geographic position coordinates are automatically changed as the location of the consumer device changes, and wherein the merchant presence changes in response to the changed locations of the consumer device.

10. The method of claim 1 wherein transmitting the merchant presence includes selecting at least one of a protocol and a format that is compatible with the consumer device and wherein the merchant presence is transmitted using at least one of the compatible protocol and format.

11. The method of claim 10 wherein the at least one of the compatible protocol and format is selected from a group consisting of HTML, XHTML, Web format, Wireless Application Protocol, Wireless Markup Language (WML), Voice extensible Markup Language (VoiceXML), Short Message Service (SMS), and E-mail.

12. The method of claim 10 wherein the merchant presence includes a merchant Web page so as to allow the act of presenting to present the merchant Web page to the consumer if the consumer device has the capability to view the merchant Web page.

13. The method of claim 10 wherein the merchant presence includes a merchant E-mail address so as to allow the act of presenting to present the merchant E-mail address to the consumer if the consumer device has the capability to communicate with the merchant through E-mail.

14. The method of claim 1 wherein the merchant presence includes an audio file so as allow the act of presenting to transmit an audio message to the consumer device if the consumer device has the capability to receive an audio file.

15. The method of claim 1 wherein the merchant presence includes a mark of the merchant so as to allow the act of presenting to present the mark to the consumer device.

16. The method of claim 1, further including tracking the activity of each consumer in regard to transmissions of the merchant presence, and wherein the act of tracking is selectively enabled by at least one of the consumer or the merchant.

17. The method of claim 1 wherein presenting includes transmitting a form to interact with the consumer to so as to conduct business.

18. A method for providing a merchant presence to a consumer, comprising:
receiving information in an electronic medium that includes a geographic point of origin and service area defined by the merchant, where the merchant presence includes a description of goods and/or services offered the merchant, and;
receiving an indication of the physical presence of a consumer device within the service area of the merchant; and
transmitting the merchant presence to the consumer device if the indication of the physical presence of the consume device is within the service area defined by the merchant.

19. A system for presenting a merchant presence to a consumer, comprising:
a presence server that stores merchant information defining the merchant presence in an electronic medium, the merchant information including a defined location for the merchant and a category of goods and/or services offered by the merchant;
a device interface operably configured with the presence server to format the merchants presence to be compatible with consumer device in at least one of a protocol and format; and
a communication port operably configured with the presence server to receive an indication of the consumer's location and to actively transmit the formatted merchant presence to the consumer device if the indication of the consumer's location overlaps with the defined location for the merchant.

20. The system of claim 19, further configured to communicate with a location service provider to receive the indication of the consumer's location and to receive an indication of the at least one of the protocol and format of the consumer device from the location service provider.
